(19) United States
(12) Patent Application Publication
(10) Pub. No.: US 2004/0121819 A1
(43) Pub. Date: Jun. 24, 2004

(54) Hands-free device for operating mobile telephones in motor vehicles

(76) Inventor: Frank Vogel, Schwarzenbruck (DE)

Correspondence Address: FULBRIGHT & JAWORSKI, LLP, 1301 MCKINNEY, SUITE 5100, HOUSTON, TX, 77010-3095, US

(21) Appl. No.: 10/470,323

(22) PCT Filed: Jan. 26, 2002
(86) PCT No.: PCT/DE02/00269

(30) Foreign Application Priority Data
Jan. 28, 2001 (DE) 101 03 610.8

(51) Int. Cl. H04M 1/00; H04M 9/00

(52) U.S. Cl. 455/569.2; 455/575.9; 379/419

(57) ABSTRACT

Set forth are developments such as automatically optimizing interface configuration, entitlement checking, data encryption in relation to a commercially available hands-free device for the operation of mobile telephones in motor vehicles.

The invention concerns a hands-free device for the operation of mobile telephones in motor vehicles.

A hands-free device of that kind is known from the ADAC magazine GUTE FAHRT issue 6/1998, in the form of an installation system which can be employed universally, namely for most commercially available mobile telephones (which are also referred to as mobiles), with an optional connection to the car radio for muting and use of the loudspeaker thereof. The versatile utility of that system in that known hands-free device, is based on a functional division into two aspects, to the effect that an interface module with microprocessor, which is to be installed fixedly in relation to the vehicle, is provided for adaptations on the vehicle side, including control of the hands-free components, while all equipment-specific requirements (operating program and data) are stored in a memory in the apparatus-specific plug of an item which is referred to herein as the system cable and which connects the interface module to a holder for the mobile telephone, which is of a dish-shaped configuration specific to the apparatus involved and referred to in practice as the cradle. The communication between those two system parts is implemented by the microprocessor contained in the interface module, by way of two serial interfaces.

With that known hands-free device therefore, the user, in relation to his mobile telephone which is currently in use, only needs to have a holder which is mechanically suited thereto, together with an electrically appropriate system cable, in order to be able to use that hands-free device when installed in the vehicle. Therefore the vehicle to be used can be freely changed or a vehicle can be driven by various users with their different mobile telephones without having to contravene the prevailing prohibitions on using a mobile telephone by hand in the motor vehicle when ready for operation. The device-specific holder (cradle) for shock-resistantly receiving the associated mobile telephone can be latched in such a way that it can be manually easily exchanged, on a mounting unit which is mounted fixedly with respect to the vehicle. Plugging in the system cable or starting the engine when the cable is plugged in initiates programming of the interface module, that is to say the device-specific operating data set is loaded from the system cable plug into the microprocessor and the program thereof is thereby executed in a device-specific fashion.

That device which permits duplex hands-free operation has proved its worth in a practical context.

Now, the object of the present invention is to also improve the hands-free device of the general kind set forth, in regard to future requirements in particular in respect of reliable and secure transmission of even larger varieties of data.

In accordance with the invention that object is attained by the subject-matter of claim 1. This involves a hands-free device for the operation of mobile telephones in motor vehicles, which are respectively equipped with an interface module which contains vehicle-specific data and a mounting unit for an easily replaceable device-specific holder with device-specific data. It is provided in that respect that on the one hand the interface module and on the other hand the mounting unit and/or the holder each have a respective microprocessor. By way of the microprocessors which preferably communicate with each other by way of a bus, it is now possible in accordance with aspect a) of claim 1 to implement an automatically optimizing interface configuration and/or in accordance with aspect b) of claim 1 to implement entitlement checking and/or in accordance with aspect c) of claim 1 to implement data encryption and/or data compression. The hands-free device can thus also be used without any problem for mobile telephones of the future UMTS-generation. Reliable and secure transmission is guaranteed even with a wide diversity of data.

For automatic interface configuration, it is provided in accordance with the combination of features a) that the microprocessors communicate with each other by way of a serial, selectively synchronously or asynchronously operable interface by way of a bus in order at the beginning of operation to configure the interface in accordance with the current equipment combination. The interface configuration procedure can be triggered for example when the interface module sends a change-over switching command back to the mounting unit because it can support the set of interface parameters, that has just been received.

For entitlement checking it is provided in accordance with the combination of features b) that the microprocessors communicate with each other by way of a serial, selectively synchronously and asynchronously operable interface by way of a bus in order to implement entitlement checking in respect of the admissibility of operation of a mobile telephone at the present interface module.

Data encryption in accordance with the combination of features c) is effected in that the microprocessors which preferably communicate with each other by way of a bus execute data encryption. In this case the first character of a data telegram can be a synchronization character which is known at the receiver end and which at the transmitter end is coded in accordance with a predetermined law, whereupon the other characters of the data telegram to be sent are coded in accordance with the same law while at the receiver end the first character is converted back into the expected synchronization character whereupon also the other characters of that telegram are treated in the same manner.

Data compression can be effected by one of the established standard processes.

In the case of this hands-free device in which, as discussed, the interface configuration can be automatically optimized, and/or entitlement checking and/or data encryption and data compression can be effected, the device-specific holder equipped with a processor preferably acts only as a control unit for the device-specific functions of the mobile telephone which is precisely to be operated, such as in particular interface transfer and battery charge cycle. The device-specific data stored in the processor of the holder relate preferably primarily to the power class of the mobile telephones, to a lesser degree or not at all to manufacturer-specific data, so that a holder has to be exchanged essentially only when changing over to another power class and therefore replacement of the holder is not absolutely required upon each change in the mobile telephone. It is possible to forego identification of the mobile telephone which is just being operated, as the control units between the holder and the interface module co-operate in device-independent fashion and indeed preferably serially. All vehicle-specific functions are copied in the interface module with its processor and the optimum functions of the universal hands-free device can also be activated in conjunction therewith. An interface module can be designed for at least one type class of different vehicles. For data traffic, automatic tuning is effected between the holder and the interface module which are connected by way of the bus. The interface configuration procedure takes place by way of data exchange, more specifically preferably at optimum speed and data security between the data bus subscribers.

In particular this automatic interface configuration procedure can be linked with the entitlement checking procedure and with data encryption.

In particularly preferred embodiments the interface module can be provided with speech recognition means for hands-off speech control.

If a control device should already be installed in the motor vehicle, for example for the automobile radio, for a television, for a navigation unit or for a communication system such as Telematic or as Internet access, the mounting unit which is connected for example by means of a cable connection or preferably a direct plug connection to the telephone holder can also be connected directly to the control device, instead of to a specific interface module of the hands-free device.

Basically, the cable connection for the bus between the interface module and the mounting unit for the telephone holder can be replaced or supplemented by a remote control means which can preferably also be used for functions other than for operation of the hands-free device, more specifically in particular for those functions which in modern vehicles can be activated from a multi function-implementing steering wheel.

Finally, a connection option which is now afforded by a material or cablelessly immaterial bus connection between the interface module and the mounting unit for the holder, in respect of a plurality of holders which are also designed for entirely different power classes, to a common, preferably single interface module in the vehicle, is an aspect of increased practical interest in particular for company vehicles.

In order not to have to remove the mobile telephone from its holder for telephone conversations in the private mode, the mounting unit thereof, which is fixed with respect to the vehicle, can be equipped with a transmitter-receiver for wireless communication for example by way of a headphone and microphone of a headset, or can be retro-fitted therewith.

Use is intended in all motor vehicles, that is to say private vehicles and commercial and public vehicles of all kinds. Use in rail vehicles is also envisaged. This generally involves use in land vehicles, but use in for example sports boats and sports aircraft is also correspondingly possible.

In regard to details of the structures according to the invention and developments thereof, besides the claims which can all also be in mutual dependency on each other in terms of content, attention is also directed to the description hereinafter which, on the basis of a preferred embodiment by way of example of the invention, which is shown diagrammatically in the drawing being simplified to the essential features, describes the basic functions and possible developments of the invention in greater detail.

In the drawing:

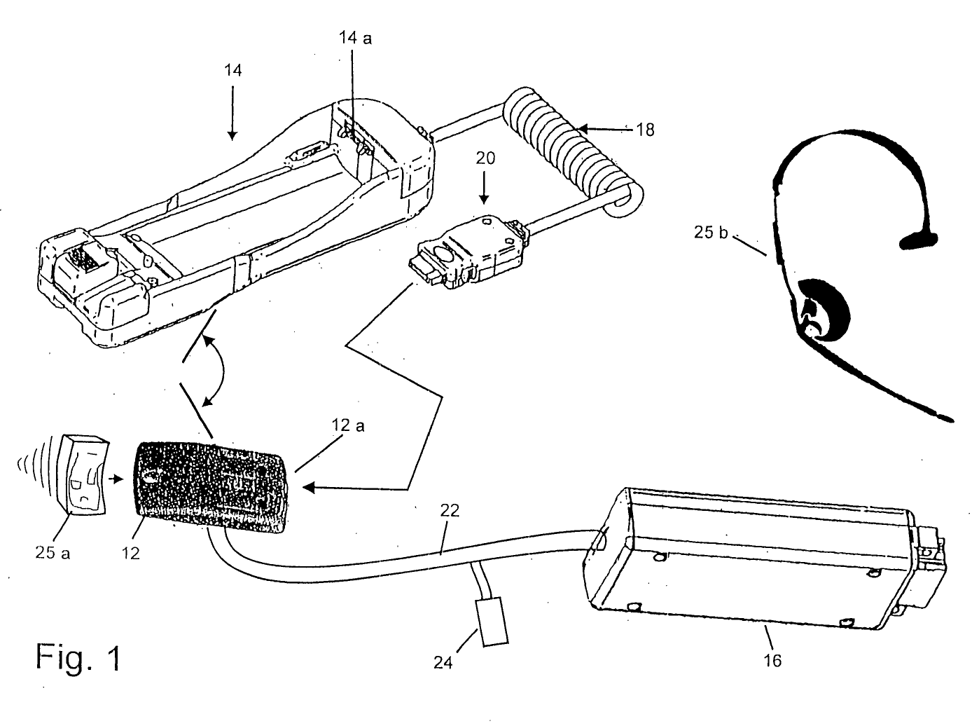

FIG. 1 is an exploded view of an embodiment of a hands-free device.

The illustrated embodiment involves a motor vehicle hands-free device which can be employed universally in respect of the most widely varying types and power classes of mobile telephones which are currently on the market, the hands-free device being referred to for brevity as a universal hands-free device.

A universal interface module 16 which is to be installed fixedly in the vehicle is designed independently of the various mobile telephones (not shown). It communicates in data exchange or with level control but independently of the device involved, by way of a material or immaterial bus 22 and by way of a mounting unit 12, which is also mounted fixedly in the vehicle, for a holder 14 which is of a device-specific configuration and which is to be easily interchangeably fixed thereon. That communication is effected between a respective microprocessor on each side of the bus connection, namely a microprocessor on the one hand in the interface module 16 and a microprocessor on the other hand in the holder 14 or in the mounting unit 12, by way of only one single serial interface which can be operated physically synchronously and asynchronously. A holder 14 can co-operate by way of its mounting unit 12 selectively with different interface modules 16 and an interface module 16 can co-operate with any holders 14, for which purpose device-independent interface adaptation is effected reciprocally prior to initiation of data exchange. This means that no fixed device-technical association between the holder 14 and mounting units 12 or interface modules 16 has to be observed, but the user, for his mobile telephone, can freely connect the holder 14 to the mounting unit 12 which is to be found for example in a hire car.

The device-specific holder 14— in practice referred to as the cradle —which is equipped with a processor in turn acts only as a control unit for the device-specific functions of the mobile telephone which is precisely to be operated at that time, such as in particular interface transfer and battery charging cycle. For that purpose, a plug 14a is positioned on the substantially cradle-shaped holder 14 in such a way that the plug co-operates with the corresponding terminal locations of the specific mobile telephone which is fitted into the holder 14. The electrical and in particular data connection between the holder 14 and the mounting unit 12 is made by way of a connection unit which can involve a system cable 18, the plug 20 of which is plugged in at the associated socket 12a in the mounting unit 12; or however, instead of that cable plug connection, there is provided a corresponding plug connection 12b directly between the mounting unit 12 and the holder 14 and which becomes operative when the holder 14 is fitted onto the mounting unit 12. The device-specific data stored in the processor of the holder 14 relate primarily to the power class of the mobile telephones, less to manufacturer-specific data, so that a holder 14 has to be replaced essentially only when changing over to another power class, but not necessarily when simply changing mobile telephones (provided only that the terminals thereof still match the installed plug 14a).

To change the mobile telephone it is necessary to replace the holder 14 with its device-specific software. It is possible to forego identification of the mobile telephone which is being operated, as the control units between the holder 14 and the interface module 16 co-operate serially, that is to say universally and therefore in a device-independent fashion. Data exchange takes place here by way of the bus 22 with a synchronous data channel in which, for all the systems involved (that is to say in particular the holder 14 and the module 16) all characters occur identically in a fixed time raster or in an accurately mutually matched clock. The clock signal can be carried on a separate line or modulated on the data stream. The data blocks begin and end with a synchronization character. In this way even the greatly increasing amounts of data which are to be expected with the introduction of the UMTS-network can be managed, but could no longer be managed with conventional asynchronous interfaces, that is to say with the asynchronous data transfer which is to be encountered at the present time. Additional amounts of data for the processing of items of satellite navigation information, Internet accesses, SMS traffic and the like then also no longer represent a problem. In the interests of device flexibility however, the system provides a change-over switching option between synchronous and asynchronous data exchange.

All vehicle-specific functions are copied in the interface module 16 with its processor and in conjunction therewith it is also possible to activate the optional functions of that universal hands-free device such as in particular echo elimination which is common in the communications art, noise suppression, speech recognition and control or text-speech conversion. At the same time that processor is designed as a transceiver in relation to the data bus of the vehicle. Finally it serves the hands-free device as an audio amplifier. An interface module 16 can be designed for at least one type class of different vehicles in order to arrive at larger production shares.

When the mobile telephone is latched in its holder 14 and thereby connected to the plug 14a, the hands-free function is activated by the interface module 16 and switched into the operational position for the situation where a telephone conversation is conducted. That is to say, in the case of a telephone conversation, then in particular the external microphone and the external loudspeaker (both are not shown in the drawing and are for example already present in the automobile radio) are switched on and the mute signal mutes the automobile radio. When the version involved is one in which the cradle 14 is connected to the mounting unit 12 by way of the system cable 18 with plug 20, then with the holder 14 (with inserted mobile telephone) being removed from the mounting unit 12 the above-mentioned operational position is switched over from hands-free to a private mode and in the situation where a telephone conversation is being held, the external loudspeaker and the external microphone are switched off and the radio muted by way of a mute signal.

So that even for this mode of operation in the private mode, there is no need to perform manual handling procedures such as removing the mobile telephone from its holder 14— which in any case in the meantime are prohibited in the motor vehicle when in the operational condition—, the mounting unit 12 is desirably equipped with a plug socket for a small transmitter-receiver 25a which for example using bluetooth communicates multi-channel wireless signal transmission by way of radio or infrared to a corresponding transmitter-receiver of a headset 25b with headphone and microphone.

Instead of or in addition to the transmitter-receiver 25a which is in the form of an audio module and which is provided in the arrangement shown in FIG. 1, a Personal Digital Assistant, a so-called PDA or mini-PC, can be connected to the mounting unit 12 by way of cable or cablelessly, for example by way of radio or bluetooth.

Preferably, this connection option is provided in design configurations in FIG. 1, in which the holder 14 does not have a connection cable 18 but can be connected to the mounting unit 12 by way of the electrical plug connection and the mounting unit 12 has suitable electronics, preferably a microprocessor. The PDA (not shown in FIG. 1) can be fixed by means of a holder which is stationary in the motor vehicle, preferably the arrangement can be in the proximity of the mounting unit. With the connection of the PDA, it then becomes possible for SMS or mail messages received by way of the mobile telephone to be displayed or read out at the display of the PDA. In addition it is also possible with the connection of the PDA to produce an Internet access in the motor vehicle, in which case the PDA already affords the necessary technology, that is to say computing power, operating system and browser and so forth. With the possibility of an Internet connection, it is possible also to navigate the route by way of a service provider, for example Passo. In addition it is possible to actuate the hands-free device or the mobile telephone by way of the PDA, by virtue of the fact that the data are inputted into the PDA or data stored in the PDA are used, for example the telephone book of the PDA can be used for number dialing.

For data traffic, automatic tuning takes place between the holder 14 and the interface module 16, completely independently of the mobile telephone which is just to be operated. Prior to interface configuration, the asynchronous basic setting of the bus subscribers prevails. After switching-on or plugging the holder 14 into the bus 22 to the interface module 16 the holder 14 listens to the bus in the basic setting. If the holder 14 does not receive an initialization identification within a predetermined period of time of the order of magnitude of for example three seconds, the holder 14 switches over its interface to level control because evidently no operational interface module 16 or one with level control instead of with processor execution control is connected to the system; in other words, then, no data telegrams are sent, but interface control is effected by way of analog signals and thus in an operating mode in which certain basic comfort functions such as muting of the automobile radio in the event of radio communication and loudspeaker regulation thereof still continue to function. When making the connection therefore, to expedite initialization, no additional loading due to any exchange of system-specific data of the mobile telephone which is just being used occurs. The current data exchange only ever relates to data which are typical in respect of the holder 14 and the interface module 16 with their integrated processors, it does not include any data which are device-typical in respect of the mobile telephone.

The module 16 firstly cyclically sends an initialization identification for forming the communication, until, upon the connection of a holder 14, by way of the bus 22, an initialization response comes from the holder 14. In that way interface configuring can be implemented by way of data exchange, namely at optimum speed and data security between data bus subscribers of various development stages.

If the connection is successfully made in that way, the interface module 16 sends to the holder 14 its interface parameters which represent a best possible interface connection from the point of view of the interface module 16. This means that the holder 14 returns the parameters of the interface module 16 when they are supported by the holder 14 and when they are better than the parameters of the holder 14; otherwise it sends its own parameters back (maximum requirement of the interface module 16). If the interface module 16 should not be able to support the interface parameters received by way of the bus 22, it sends new parameters to the holder 14, which at the highest involve the same requirements as the parameters just received from the holder 14. After a predetermined number of for example three unsuccessful parameter proposals however, the system remains at the above-mentioned basic setting.

The interface configuration operation is triggered if the interface module 16 sends back a change-over switching command because it can support the currently received set of interface parameters. In that way the holder 14 and the interface module 16 switch over to the new configuration. With that, the currently applicable parameters are then exchanged once again for testing purposes. Now, a digital communication can take place between the holder 14 and the interface module 16 by way of the bus 22.

In order to be able to automatically authorize the useful communication between the holder 14 and the interface module 16, entitlement checking is desirable in order to be able to very substantially exclude possible operational disturbances as a result of incompatibilities. The entitlement checking procedure therefore relates less to the user than in particular to the fact that under some circumstances components of a given design configuration may only be operated in certain types of vehicle. It desirably directly follows the above-described, successfully concluded interface configuration procedure. It is only if the identifications in the form of code numbers in respect of the holder 14 and/or the interface module 16, which are allocated for various vehicle manufacturers or operators by the supplier of the hands-free installation in relation to the respective type of vehicle, are associated with each other in paired relationship, that data traffic can take place, that is to say the communication can occur by way of this hands-free installation.

In that respect, data compression on the bus 22 from the mounting unit 12 (that is to say ultimately from the telephone holder 14) to the interface module 16 is desirable in order here to be able to keep down the required transmission band width and accordingly the expenditure in respect of noise suppression measures. For the compression effect, recourse is had to one of the common standard methods, for cost reasons. Additional encryption of the data traffic is an effective means against any unauthorized interventions in the interface configuration. In the present connection it is sufficient for the coding operation to forego the transmission of characters in plain text, insofar as one of the known, fast encryption processes is implemented at the lowermost level, avoiding a repetition of identical character patterns. Preferably the first character of a data telegram, which is the synchronization character which is also known at the receiver end, is subjected to quasi-random treatment in accordance with given laws. At the reception end the first received character is then converted back into the known synchronization character and the data sequence which thereupon appears is also handled in accordance with the laws which are applicable in respect thereof. The transmitter therefore codes all characters of a telegram in accordance with the same pattern (in respect of shift and interlinking of its bits), which is predetermined for the synchronization character. The receiver passes the first received character back to the bit sequence of the known synchronization character and then also applies the procedure (in respect of shift and interlinking of the bits of a character) to the following characters of the telegram. By continually changing the coding, the telegrams even of such data which are multiply transmitted due to the operating procedure involved or to afford redundancy enhancement are always of a different appearance at the interface.

As the interface module 16 is preferably designed for the option of use in different vehicles, it is desirable to implement therein additional functions which are activated only when required. Such an additional function is speech control of the holder 14 and thus the mobile telephone, which however can also be called upon to control vehicle functions. That can be implemented in a particularly problem-free manner in relation to functions which in any case are functionally linked to the interface module 16, such as the automobile radio, the loudspeaker of which is used for the hands-free device. Then however the vocabulary to be recognized can also be inputted in identical manner for the acoustic control for example of comfort functions which are related to the motor vehicle universal bus, such as seat adjustment, window lifter, navigational display and the like, without that involving an increase in apparatus expenditure.

In accordance with the present invention it is even possible to forego the installation of an independent interface module (16) if the function thereof is already implemented in some other fashion in the motor vehicle, such as for example in the function of a Telematic box as a universal control device for example for automobile radio, television, Internet access and navigation system, which can then also be used for the present hands-free device.

It is particularly desirable for the holder 14 in accordance with the present invention to be connected to a communication port of an automobile radio with universal input keyboard and display. For, in that case the holder together with its mobile telephone can be enclosed for example in the glove compartment because now—in addition to the loudspeaker and the microphone—the automobile radio is used for operating and display functions of the mobile telephone. The connection of the holder to the radio equipment of the motor vehicle can be implemented with minimum additional cabling complication and expenditure by way of a further interface, by way of which telephone-specific data sets such as addresses and connection numbers, SMS-telegrams or service data can also be transmitted out of and likewise into the vehicle.

An ergonomically advantageous arrangement of operating elements on the mounting unit 12 which is optimized for easily removably accommodating the holder 14 is not readily possible. Therefore, for switching on the hands-free device or its speech recognition means, it is desirable to have a small control device which is self-sufficient as it is battery-powered and which accordingly can be positioned as desired in the passenger compartment, including in relation to the passengers on the rear seats, having a few keys, among which there can be an emergency call key but also operating options for controlling information displays or for example multi-media applications in the motor vehicle. In particular, the device can also have at least one so-called “push-to-talk” key, by way of which speech control of the hands-free device and/or other devices installed in the vehicle can be switched on/off. In addition keys for controlling pure vehicle functions such as window lifters, seat adjustment and so forth can also be provided on the device. Signal transmission to the holder of the mobile telephone, that is to say therefore into the control means thereof and further therefrom to the motor vehicle bus, is desirably effected wirelessly, in particular by way of an infrared communication which can be inexpensively produced using common components. That affords options which otherwise are only to be encountered to a limited extent in the highest level of equipment involving a multi-function steering wheel.

Because a bus 22 is provided for the communication between the interface module 16 and the mounting unit 12 for the holder 14, it is possible without any problem for a plurality of mobile telephones with their holders 14 to be additionally connected to the single interface module 16 of a vehicle and managed from there, which impressively underlines the universal applicability of the hands-free device according to the invention.

1. A hands-free device for the operation of mobile telephones in motor vehicles, for example private automobiles, buses and trucks and other utility vehicles, comprising an interface module (16) which can be installed in the motor vehicle and which includes a microprocessor with stored vehicle-specific data and a mounting unit (12) which can be installed in the motor vehicle for an easily interchangeable, device-specific holder (14) for temporarily receiving a mobile telephone, with device-specific data stored on a microprocessor,
wherein it is provided
a) the microprocessors communicate with each other by way of a serial, selectively synchronously and/or asynchronously operable interface, by way of a bus (22), in order at the beginning of operation to configure ace in accordance with the current equipment combination; and/or
b) the microprocessors communicate with each other by way of a serial, selectively synchronously and/or asynchronously operable interface, by way of a bus (22), in order to execute entitlement checking in respect of the admissibility of the operation of a mobile telephone at the present interface module (16); and/or
c) the microprocessors which preferably communicate with each other by way of a bus (22) implement data encryption and/or data compression.

2. A hands-free device as set forth in claim 1 characterized in that an interface configuration procedure is triggered when the interface module (16) sends a change-over switching command back to the mounting unit (12) because it can support its set which has just been received of interface parameters.

3. A hands-free device as set forth in one of the preceding claims characterized in that the first character of a data telegram is a synchronization character which is known at the receiver end and which at the transmitter end is coded in accordance with a predetermined law quasi-randomly, preferably by rotation and/or interlinking of a bit sequence, whereupon the other characters of the data telegram to be transmitted are coded in accordance with the same law, while at the receiver end the first character is correspondingly converted back into the expected synchronization character, preferably by bit rotation and/or interlinking, whereupon also the other characters of said telegram are treated in the same manner.

4. A hands-free device as set forth in claim 3 characterized in that the law is altered for successively occurring data telegrams.

5. A hands-free device as set forth in one of the preceding claims characterized in that a cableless plug connection (12b) is provided between the holder (14) and the mounting unit (12) and/or that a cable connection (18) with plug (20) is provided between the holder (14) and the mounting unit (12) or that there is no electrical connection between the holder (14) and the mounting unit (12) but a cable connection with plug between the holder (14) and the interface module (16).

6. A hands-free device as set forth in one of the preceding claims characterized in that the holder (14) and/or the mounting unit (12) can be connected to a control device which is present in any case in the motor vehicle, for example for the operation of an automobile radio, a television, a navigation system, the Internet or a communication system such as for example Telematic.

7. A hands-free device as set forth in one of the preceding claims characterized in that the holder (14) and/or the mounting unit (12) can be connected to an interface module (16) which can be installed in the motor vehicle with vehicle-specific data preferably stored on a microprocessor and a cableless remote control device can be connected to the holder (14) and/or the mounting unit (12) and/or to the interface module (16), wherein it is preferably provided that by way of the remote control device such functions other than the hands-free device in the motor vehicle can also be remotely controlled, as would be actuable for example by way of a multi function-implementing steering wheel,
wherein it is preferably provided that
the interface module (16) to which the holder (14) and/or the mounting unit (12) can be connected by way of the cableless remote control device is in the form of an interface module (16) and/or a control device, which is present in any case in the motor vehicle, for example for the operation of an automobile radio, a television, a navigation system, the Internet and/or a communication system such as for example Telematic.

8. A hands-free device as set forth in one of the preceding claims characterized in that the holder (14) and/or the mounting unit (12) can be connected to an interface module (16) which can be installed in the motor vehicle with vehicle-specific data preferably stored on a microprocessor, which is also equipped with a speech recognition means for verbal control of the hands-free device and preferably also other functions in the motor vehicle,
wherein it is preferably provided that
the interface module (16) equipped with the speech recognition means is in the form of an interface module (16) or control device, which is present in the motor vehicle in any case, for example for the operation of an automobile radio, a television, a navigation system, the Internet or a communication system such as for example Telematic.

9. A hands-free device as set forth in one of the preceding claims characterized in that there are provided a plurality of holders (14) and/or mounting devices (12) which each have a respective microprocessor and which can be connected to a bus (22) to a common interface module (16) which can be installed in the motor vehicle and which preferably has a microprocessor.

10. A hands-free device as set forth in one of the preceding claims characterized in that to connect the microprocessor of the holder (14) or the mounting unit (12) respectively to the microprocessor of the interface module (16) there is provided a bus which is preferably in the form of a cablelessly immaterial bus.

11. A hands-free device as set forth in one of the preceding claims characterized in that the mounting unit (12) and/or the holder (14) is provided with a transmitter-receiver (25a) for wireless audio connection to a transmitter-receiver at a headset (25b) with headphone and microphone.

12. A hands-free device as set forth in claim 11 characterized in that the transmitter-receiver (25a) of the mounting unit (12) or the holder (14) respectively is in the form of a separate and/or retro-fittable structural unit.

13. A hands-free device as set forth in claim 11 or 12 characterized in that the audio connection is of such a circuitry that it is switched on when the hands-free device is switched into the private mode and in that case the headphone and microphone of the headset (25b) are automatically switched on and preferably the external loudspeaker and microphone of the hands-free device are switched off.

14. A hands-free device as set forth in one of claims 11 through 13 characterized in that the audio connection can be switched on/off by way of a switch which can be actuated by hand and/or by way of a speech control means.

15. A hands-free device as set forth in claim 14 characterized in that the switch which can be actuated by hand is arranged in the region of the transmitter-receiver of the mounting unit (12) or the holder (14) respectively and/or in the region of the transmitter-receiver of the headset (25b).

16. A hands-free device as set forth in one of the preceding claims characterized in that, when the private mode is switched on, the holder (14) is arranged at and/or on the mounting unit (12).

17. A hands-free device as set forth in one of the preceding claims characterized in that a computing and/or memory and/or display device can be connected to the mounting unit (12) and/or the holder (14) and/or to the interface module (16).

18. A hands-free device as set forth in claim 17 characterized in that the computing and/or memory and/or display device which can be connected to the mounting unit (12) and/or the holder (14) and/or to the interface module (16) is in the form of a computer with display, preferably a laptop or notebook, or in particular in the form of a Personal Digital Assistant (PDA) or organizer or minicomputer.

19. A hands-free device as set forth in claim 18 characterized in that the computing and/or memory and/or display device is connectable by way of cable or cablelessly, for example by way of radio or bluetooth.

20. A hands-free device as set forth in one of the preceding claims characterized in that the mounting unit (12) has a bracket (12) or the like which can be mounted stationarily in the motor vehicle, wherein the bracket (12) can preferably be mounted to the instrument panel or to the central console or to the arm rest or in or at the glove compartment or in or at a door, preferably the inside of a vehicle door.

21. A hands-free device as set forth in claim 20 characterized in that the bracket (12) has a fixing side which is adapted to the fixing location at the instrument panel, the central console or the armrest.

22. A hands-free device as set forth in one of the preceding claims characterized in that the holder (14) adapted for temporarily receiving the mobile telephone can be temporarily connected to the bracket.

23. A hands-free device as set forth in one of the preceding claims characterized in that the holder is in the shape of a receiving means preferably adapted in a cradle form to the mobile telephone for temporarily receiving the mobile telephone.

24. A hands-free device as set forth in one of the preceding claims characterized in that the holder (14) has an electrical connection for the mobile telephone and preferably a control unit, in particular with microprocessor.

25. A motor vehicle with a hands-free device as set forth in one of the preceding claims installed therein.
